(19) United States
(12) Patent Application Publication
(10) Pub. No.: US 2022/0349289 A1
(43) Pub. Date: Nov. 3, 2022

(54) SYSTEM AND METHOD FOR OPTIMIZING A PERORATION SCHEMA WITH A STAGE OPTIMIZATION TOOL

(71) Applicant: HALLIBURTON ENERGY SERVICES, INC., Houston, TX (US)

(72) Inventors: Ubong Akpan INYANG, Humble, TX (US); Dinesh Ananda Shetty, Sugar Land, TX (US); Srividhya Sridhar, Bellaire, TX (US); Jie Bai, Katy, TX (US); William Ruhle, Denver, CO (US)

(21) Appl. No.: 17/245,985

(22) Filed: Apr. 30, 2021

(51) Int. Cl. E21B 43/26; E21B 47/06; E21B 47/10

(52) U.S. Cl. CPC E21B 43/26; E21B 47/06; E21B 47/10; E21B 2200/20; E21B 2200/22

(57) ABSTRACT

Aspects of the subject technology relate to systems and methods for improving cluster and surface efficiency in hydraulic fracturing by utilizing a stage optimization tool. Systems and methods are provided for receiving one or more perforation parameters of a wellbore, generating a perforation schema based on the one or more perforation parameters, training a stage optimization model based on the perforation schema to generate an optimized perforation schema, estimating a pressure of the wellbore based on the optimized perforation schema, and updating the optimized perforation schema until the estimated pressure is less than a predetermined pressure limit.

### TECHNICAL FIELD

The present technology pertains to optimizing a perforation schema in hydraulic fracturing, and more particularly, to generating an optimized perforation schema that maximizes a flow distribution by utilizing a stage optimization tool.

### BACKGROUND

Hydraulic fracturing enhances hydrocarbon production by injecting a fracturing fluid into a subsurface formation. The fracturing fluid is injected into the formation at a high rate to exert sufficient pressure to create fractures. The fracturing fluid may suspend proppant particles that are placed in the fractures to prevent the fractures from fully closing and allow hydrocarbons to flow from the reservoir to the wellbore. Therefore, it is critical to maintain a fluid and proppant transport through the wellbore, perforations, and fractures so that a uniform proppant placement across clusters can be achieved.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic diagram of an example fracturing system, in accordance with aspects of the present disclosure.

FIG. 2 illustrates a well during a fracturing operation in a portion of a subterranean formation of interest surrounding a wellbore, in accordance with aspects of the present disclosure.

FIG. 3 illustrates a portion of a wellbore that is fractured using multiple fracture stages, in accordance with aspects of the present disclosure.

FIG. 4 illustrates an example fracturing system for concurrently performing fracturing stages in multiple wellbores, in accordance with aspects of the present disclosure.

FIG. 5 illustrates an example block diagram of an inter-stage optimization process, in accordance with aspects of the present disclosure.

FIG. 6 illustrates an example process for utilizing a stage optimization model to optimize a perforation schema, in accordance with aspects of the present disclosure.

FIG. 7 illustrates an example graph of a performance comparison of a uniformity index, in accordance with aspects of the present disclosure.

FIG. 8 illustrates an example graph of a uniformity index in different stages, in accordance with aspects of the present disclosure.

FIG. 9 illustrates an example process for optimizing a time saving parameter, in accordance with aspects of the present disclosure.

FIG. 10 illustrates an example chart of well optimization, in accordance with aspects of the present disclosure.

FIG. 11 illustrates an example computing device architecture that can be employed to perform various steps, methods, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Hydraulic fracturing is a stimulation treatment process that improves well productivity by forming fractures in a formation from a wellbore. Hydraulic fracturing is typically performed by injecting a fracturing fluid into a wellbore at a high rate to exert sufficient pressure to create or extend fractures in the formation. During the fracturing operation, proppant is also injected into the formation and into the fractures to prevent fractures from closing and allow hydrocarbons to flow from the reservoir to the wellbore.

Properly stimulating perforation clusters can be an issue in the stimulation treatment process. While it can be easily assumed that all clusters are treated similarly, data from fiber optics shows an unequal distribution of fluid and proppant in the perforation clusters. Furthermore, clusters that may have been treated evenly during the start of a pad stage, can progressively become uneven as the treatment process progresses. Such uneven distribution in a slurry (i.e., mixture of suspended solids and liquids) can cause under-stimulation of the clusters, inefficient use of fracturing materials and horsepower, and sometimes well bashing. Therefore, to achieve a uniform proppant placement across the clusters, it is critical to maintain a fluid and proppant transport through the wellbore, fractures, and perforations.

A proppant placement can be affected by a perforation schema, which includes a number of perforations, a number of clusters, cluster spacing, shots per clusters, or stage length. Treatment variables such as a flow rate of slurry and fluid and a type of fracturing fluids can also influence the proppant placement.

Currently, hydraulic fracturing operators utilize a pre-determined perforation schema that typically remains similar across multiple wells even when some variables, such as a rate, a type of fluids, or formation, may change across the multiple wells. Such one-for-all perforation schema in the multiple wells can lead to uneven outcomes in the flow distribution among the clusters.

The disclosed technology addresses the foregoing by designing an optimized perforation schema to maximize a flow distribution in perforation clusters. In particular, the disclosed technology addresses the challenge of providing a completion design and a rate for the next stage by utilizing a stage optimization model that maximizes a performance index, for example, uniformity index. This invention proposes a novel method to design an optimized perforation schema depending on a given job design and vary a rate, proppant amount, fluid amount for a hydraulic fracturing job in an intelligent, data-driven manner to maximize cluster efficiency.

Furthermore, a surface efficiency can be impacted by a number of stages in the hydraulic fracturing and a pumping rate of fracturing fluids. The surface efficiency can be significantly enhanced by reducing the number of stages and therefore saving time to complete wire-line operations, pump idle time, and number of plugs utilized in the process. Therefore, there exists a need for reducing time involved in hydraulic fracturing and therefore, improving the surface efficiency.

The disclosed technology provides an inter-stage design to maximize the surface efficiency (e.g., decreased number of stages and increased pumping rate) while maintaining a certain level of performance factor.

In various embodiments, a method for improving cluster and surface efficiency in hydraulic fracturing can include receiving one or more perforation parameters of a wellbore. The method can further include generating a perforation schema based on the one or more perforation parameters. The method can also include training a stage optimization model based on the perforation schema to generate an optimized perforation schema. The method can include estimating a pressure of the wellbore based on the optimized perforation schema. The method can also include updating the optimized perforation schema until the estimated pressure is less than a predetermined pressure limit.

In various embodiments, a system for improving cluster and surface efficiency in hydraulic fracturing can include one or more processors and at least one computer-readable storage medium having stored therein instructions which, when executed by the one or more processors, cause the system to receive one or more perforation parameters of a wellbore. The instructions can further cause the system to generate a perforation schema based on the one or more perforation parameters. The instructions can also cause the system to train a stage optimization model based on the perforation schema to generate an optimized perforation schema. Furthermore, the instructions can cause the system to estimate a pressure of the wellbore based on the optimized perforation schema. The instructions can further cause the system to update the optimized perforation schema until the estimated pressure is less than a predetermined pressure limit.

In various embodiments, a non-transitory computer-readable storage medium comprising instructions stored the non-transitory computer-readable storage medium, the instructions, when executed by one or more processors, cause the one or more processors to receive one or more perforation parameters of a wellbore. The instructions can further cause the one or more processors to generate a perforation schema based on the one or more perforation parameters. The instructions can also cause the one or more processors to train a stage optimization model based on the perforation schema to generate an optimized perforation schema. Furthermore, the instructions can cause the one or more processors to estimate a pressure of the wellbore based on the optimized perforation schema. The instructions can further cause the one or more processors to update the optimized perforation schema until the estimated pressure is less than a predetermined pressure limit.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

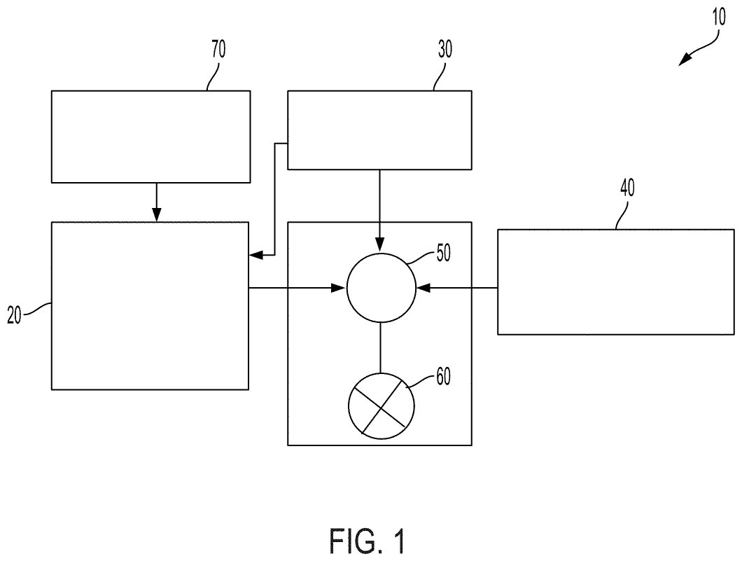

Referring to FIG. 1, an example fracturing system 10 is shown. The example fracturing system 10 shown in FIG. 1 can be implemented using the systems, methods, and techniques described herein. In particular, the disclosed system, methods, and techniques may directly or indirectly affect one or more components or pieces of equipment associated with the example fracturing system 10, according to one or more embodiments. The fracturing system 10 includes a fracturing fluid producing apparatus 20, a fluid source 30, a solid source 40, and a pump and blender system 50. All or an applicable combination of these components of the fracturing system 10 can reside at the surface at a well site/fracturing pad where a well 60 is located.

During a fracturing job, the fracturing fluid producing apparatus 20 can access the fluid source 30 for introducing/controlling flow of a fluid, e.g. a fracturing fluid, in the fracturing system 10. While only a single fluid source 30 is shown, the fluid source 30 can include a plurality of separate fluid sources. Further, the fracturing fluid producing apparatus 20 can be omitted from the fracturing system 10. In turn, the fracturing fluid can be sourced directly from the fluid source 30 during a fracturing job instead of through the intermediary fracturing fluid producing apparatus 20.

The fracturing fluid can be an applicable fluid for forming fractures during a fracture stimulation treatment of the well 60. For example, the fracturing fluid can include water, a hydrocarbon fluid, a polymer gel, foam, air, wet gases, and/or other applicable fluids. In various embodiments, the fracturing fluid can include a concentrate to which additional fluid is added prior to use in a fracture stimulation of the well 60. In certain embodiments, the fracturing fluid can include a gel pre-cursor with fluid, e.g. liquid or substantially liquid, from fluid source 30. Accordingly, the gel pre-cursor with fluid can be mixed by the fracturing fluid producing apparatus 20 to produce a hydrated fracturing fluid for forming fractures.

The solid source 40 can include a volume of one or more solids for mixture with a fluid, e.g. the fracturing fluid, to form a solid-laden fluid. The solid-laden fluid can be pumped into the well 60 as part of a solids-laden fluid stream that is used to form and stabilize fractures in the well 60 during a fracturing job. The one or more solids within the solid source 40 can include applicable solids that can be added to the fracturing fluid of the fluid source 30. Specifically, the solid source 40 can contain one or more proppants for stabilizing fractures after they are formed during a fracturing job, e.g. after the fracturing fluid flows out of the formed fractures. For example, the solid source 40 can contain sand.

The fracturing system 10 can also include additive source 70. The additive source 70 can contain/provide one or more applicable additives that can be mixed into fluid, e.g. the fracturing fluid, during a fracturing job. For example, the additive source 70 can include solid-suspension-assistance agents, gelling agents, weighting agents, and/or other optional additives to alter the properties of the fracturing fluid. The additives can be included in the fracturing fluid to reduce pumping friction, to reduce or eliminate the fluid's reaction to the geological formation in which the well is formed, to operate as surfactants, and/or to serve other applicable functions during a fracturing job. The additives can function to maintain solid particle suspension in a mixture of solid particles and fracturing fluid as the mixture is pumped down the well 60 to one or more perforations.

The pump and blender system 50 functions to pump fracture fluid into the well 60. Specifically, the pump and blender system 50 can pump fracture fluid from the fluid source 30, e.g. fracture fluid that is received through the fracturing fluid producing apparatus 20, into the well 60 for forming and potentially stabilizing fractures as part of a fracture job. The pump and blender system 50 can include one or more pumps. Specifically, the pump and blender system 50 can include a plurality of pumps that operate together, e.g. concurrently, to form fractures in a subterranean formation as part of a fracturing job. The one or more pumps included in the pump and blender system 50 can be an applicable type of fluid pump. For example, the pumps in the pump and blender system 50 can include electric pumps and/or hydrocarbon and hydrocarbon mixture powered pumps. Specifically, the pumps in the pump and blender system 50 can include diesel powered pumps, natural gas powered pumps, and diesel combined with natural gas powered pumps.

The pump and blender system 50 can also function to receive the fracturing fluid and combine it with other components and solids. Specifically, the pump and blender system 50 can combine the fracturing fluid with volumes of solid particles, e.g. proppant, from the solid source 40 and/or additional fluid and solids from the additive source 70. In turn, the pump and blender system 50 can pump the resulting mixture down the well 60 at a sufficient pumping rate to create or enhance one or more fractures in a subterranean zone, for example, to stimulate production of fluids from the zone. While the pump and blender system 50 is described to perform both pumping and mixing of fluids and/or solid particles, in various embodiments, the pump and blender system 50 can function to just pump a fluid stream, e.g. a fracture fluid stream, down the well 60 to create or enhance one or more fractures in a subterranean zone.

The fracturing fluid producing apparatus 20, fluid source 30, and/or solid source 40 may be equipped with one or more monitoring devices (not shown). The monitoring devices can be used to control the flow of fluids, solids, and/or other compositions to the pumping and blender system 50. Such monitoring devices can effectively allow the pumping and blender system 50 to source from one, some or all of the different sources at a given time. In turn, the pumping and blender system 50 can provide just fracturing fluid into the well at some times, just solids or solid slurries at other times, and combinations of those components at yet other times.

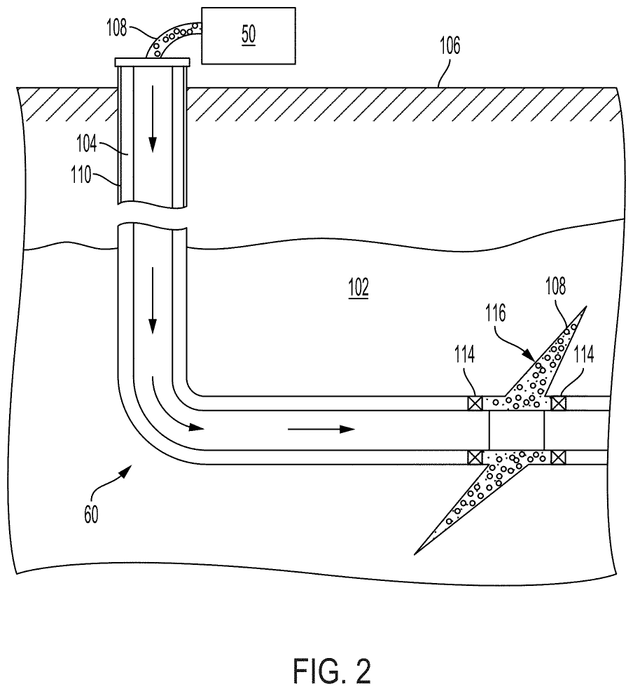

FIG. 2 shows the well 60 during a fracturing operation in a portion of a subterranean formation of interest 102 surrounding a wellbore 104. The fracturing operation can be performed using one or an applicable combination of the components in the example fracturing system 10 shown in FIG. 1. The wellbore 104 extends from the surface 106, and the fracturing fluid 108 is applied to a portion of the subterranean formation 102 surrounding the horizontal portion of the wellbore. Although shown as vertical deviating to horizontal, the wellbore 104 may include horizontal, vertical, slant, curved, and other types of wellbore geometries and orientations, and the fracturing treatment may be applied to a subterranean zone surrounding any portion of the wellbore 104. The wellbore 104 can include a casing 110 that is cemented or otherwise secured to the wellbore wall. The wellbore 104 can be uncased or otherwise include uncased sections. Perforations can be formed in the casing 110 to allow fracturing fluids and/or other materials to flow into the subterranean formation 102. As will be discussed in greater detail below, perforations can be formed in the casing 110 using an applicable wireline-free actuation. In the example fracture operation shown in FIG. 2, a perforation is created between points 114.

The pump and blender system 50 is fluidly coupled to the wellbore 104 to pump the fracturing fluid 108, and potentially other applicable solids and solutions into the wellbore 104. When the fracturing fluid 108 is introduced into wellbore 104 it can flow through at least a portion of the wellbore 104 to the perforation, defined by points 114. The fracturing fluid 108 can be pumped at a sufficient pumping rate through at least a portion of the wellbore 104 to create one or more fractures 116 through the perforation and into the subterranean formation 102. Specifically, the fracturing fluid 108 can be pumped at a sufficient pumping rate to create a sufficient hydraulic pressure at the perforation to form the one or more fractures 116. Further, solid particles, e.g. proppant from the solid source 40, can be pumped into the wellbore 104, e.g. within the fracturing fluid 108 towards the perforation. In turn, the solid particles can enter the fractures 116 where they can remain after the fracturing fluid flows out of the wellbore. These solid particles can stabilize or otherwise “prop” the fractures 116 such that fluids can flow freely through the fractures 116.

While only two perforations at opposing sides of the wellbore 104 are shown in FIG. 2, as will be discussed in greater detail below, greater than two perforations can be formed in the wellbore 104, e.g. along the top side of the wellbore 104, as part of a perforation cluster. Fractures can then be formed through the plurality of perforations in the perforation cluster as part of a fracturing stage for the perforation cluster. Specifically, fracturing fluid and solid particles can be pumped into the wellbore 104 and pass through the plurality of perforations during the fracturing stage to form and stabilize the fractures through the plurality of perforations.

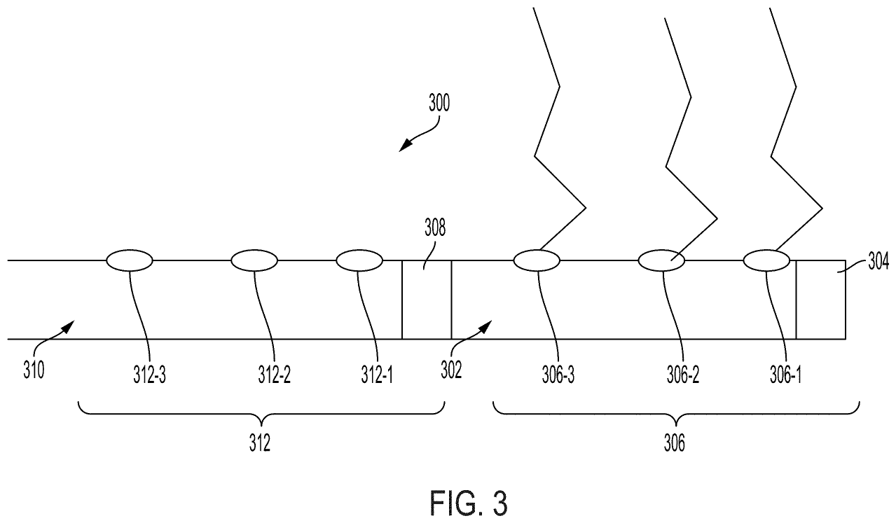

FIG. 3 shows a portion of a wellbore 300 that is fractured using multiple fracture stages. Specifically, the wellbore 300 is fractured in multiple fracture stages using a plug-and-perf technique.

The example wellbore 300 includes a first region 302 within a portion of the wellbore 300. The first region 302 can be positioned in proximity to a terminal end of the wellbore 300. The first region 302 is formed within the wellbore 300, at least in part, by a plug 304. Specifically, the plug 304 can function to isolate the first region 302 of the wellbore 300 from another region of the wellbore 300, e.g. by preventing the flow of fluid from the first region 302 to the another region of the wellbore 300. The region isolated from the first region 302 by the plug 304 can be the terminal region of the wellbore 300. Alternatively, the region isolated from the first region 302 by the plug 304 can be a region of the wellbore 300 that is closer to the terminal end of the wellbore 300 than the first region 302. While the first region 302 is shown in FIG. 3 to be formed, at least in part, by the plug 304, in various embodiments, the first region 302 can be formed, at least in part, by a terminal end of the wellbore 300 instead of the plug 304. Specifically, the first region 302 can be a terminal region within the wellbore 300.

The first region 302 includes a first perforation 306-1, a second perforation 306-2, and a third perforation 306-3. The first perforation 306-1, the second perforation 306-2, and the third perforation 306-3 can form a perforation cluster 306 within the first region 302 of the wellbore 300. While three perforations are shown in the perforation cluster 306, in various embodiments, the perforation cluster 306 can include fewer or more perforations. As will be discussed in greater detail later, fractures can be formed and stabilized within a subterranean formation through the perforations 306-1, 306-2, and 306-3 of the perforation cluster 306 within the first region 302 of the wellbore 300. Specifically, fractures can be formed and stabilized through the perforation cluster 306 within the first region 302 by pumping fracturing fluid and solid particles into the first region 302 and through the perforations 306-1, 306-2, and 306-3 into the subterranean formation.

The example wellbore 300 also includes a second region 310 positioned closer to the wellhead than the first region 302. Conversely, the first region 302 is in closer proximity to a terminal end of the wellbore 300 than the second region 310. For example, the first region 302 can be a terminal region of the wellbore 300 and therefore be positioned closer to the terminal end of the wellbore 300 than the second region 310. The second region 310 is isolated from the first region 302 by a plug 308 that is positioned between the first region 302 and the second region 310. The plug 308 can fluidly isolate the second region 310 from the first region 302. As the plug 308 is positioned between the first and second regions 302 and 310, when fluid and solid particles are pumped into the second region 310, e.g. during a fracture stage, the plug 308 can prevent the fluid and solid particles from passing from the second region 310 into the first region 302.

The second region 310 includes a first perforation 312-1, a second perforation 312-2, and a third perforation 312-3. The first perforation 312-1, the second perforation 312-2, and the third perforation 312-3 can form a perforation cluster 312 within the second region 310 of the wellbore 300. While three perforations are shown in the perforation cluster 312, in various embodiments, the perforation cluster 312 can include fewer or more perforations. As will be discussed in greater detail later, fractures can be formed and stabilized within a subterranean formation through the perforations 312-1, 312-2, and 312-3 of the perforation cluster 312 within the second region 310 of the wellbore 300. Specifically, fractures can be formed and stabilized through the perforation cluster 312 within the second region 310 by pumping fracturing fluid and solid particles into the second region 310 and through the perforations 312-1, 312-2, and 312-3 into the subterranean formation.

In fracturing the wellbore 300 in multiple fracturing stages through a plug-and-perf technique, the perforation cluster 306 can be formed in the first region 302 before the second region 310 is formed using the plug 308. Specifically, the perforations 306-1, 306-2, and 306-3 can be formed before the perforations 312-1, 312-2, and 312-3 are formed in the second region 310. The perforations 306-1, 306-2, and 306-3 can be formed using a wireline-free actuation. Once the perforations 306-1, 306-2, and 306-3 are formed, fracturing fluid and solid particles can be transferred through the wellbore 300 into the perforations 306-1, 306-2, and 306-3 to form and stabilize fractures in the subterranean formation as part of a first fracturing stage. The fracturing fluid and solid particles can be transferred from a wellhead of the wellbore 300 to the first region 302 through the second region 310 of the wellbore 300. Specifically, the fracturing fluid and solid particles can be transferred through the second region 310 before the second region 310 is formed, e.g. using the plug 308, and the perforation cluster 312 is formed. This can ensure, at least in part, that the fracturing fluid and solid particles flow through the second region 310 and into the subterranean formation through the perforations 306-1, 306-2, and 306-3 within the perforation cluster 306 in the first region 302.

After the fractures are formed through the perforations 306-1, 306-2, and 306-3, the wellbore 300 can be filled with the plug 308. Specifically, the wellbore 300 can be plugged with the plug 308 to form the second region 310. Then, the perforations 312-1, 312-2, and 312-3 can be formed, e.g. using a wireline-free actuation. Once the perforations 312-1, 312-2, and 312-3 are formed, fracturing fluid and solid particles can be transferred through the wellbore 300 into the perforations 312-1, 312-2, and 312-3 to form and stabilize fractures in the subterranean formation as part of a second fracturing stage. The fracturing fluid and solid particles can be transferred from the wellhead of the wellbore 300 to the second region 310 while the plug 308 prevents transfer of the fluid and solid particles to the first region 302. This can effectively isolate the first region 302 until the first region 302 is accessed for production of resources, e.g. hydrocarbons. After the fractures are formed through the perforation cluster 312 in the second region 310, a plug can be positioned between the second region 310 and the wellhead, e.g. to fluidly isolate the second region 310. This process of forming perforations and forming fractures during a fracture stage, followed by plugging on a region by region basis can be repeated. Specifically, this process can be repeated up the wellbore towards the wellhead until a completion plan for the wellbore 300 is finished.

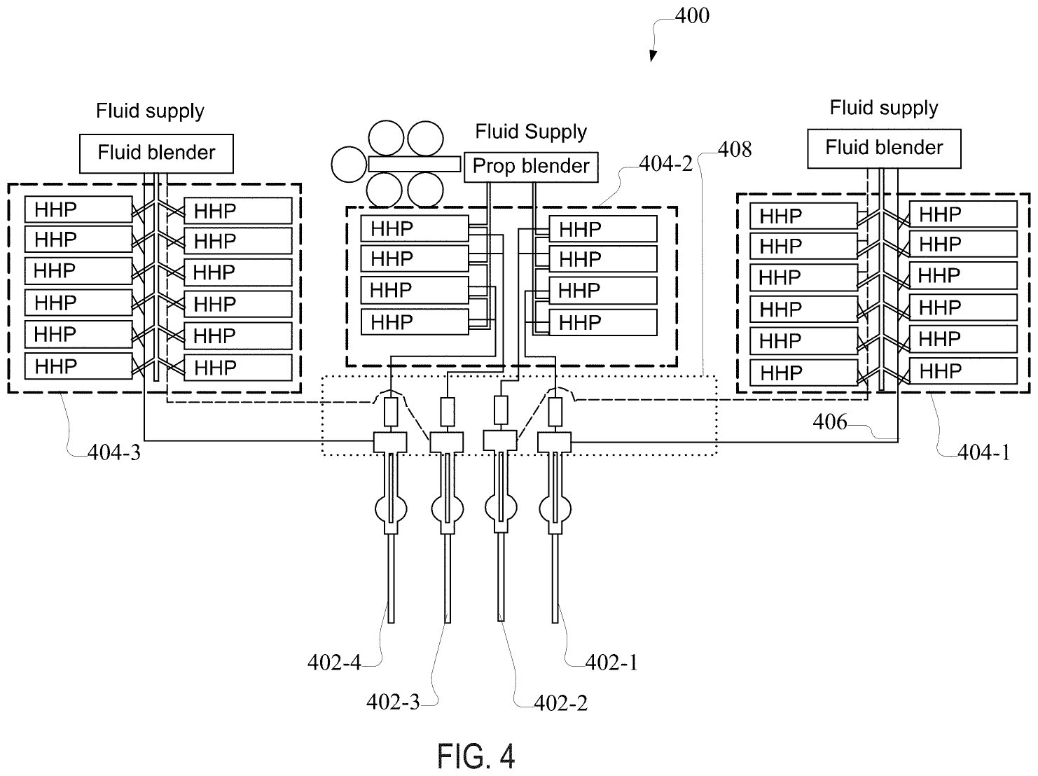

FIG. 4 shows an example fracturing system 400 for concurrently performing fracturing stages in multiple wellbores. The example fracturing system 400 can be implemented using one or an applicable combination of the components shown in the example fracturing system 10 shown in FIG. 1. Further, the example fracturing system 400 can form fractures according to the example techniques implemented in the well 60 shown in FIG. 2 and the wellbore 300 shown in FIG. 3.

The example fracturing system 400 includes a first wellbore 402-1, a second wellbore 402-2, a third wellbore 402-3, and a fourth wellbore 402-4, collectively referred to as the wellbores 402. While four wellbores 402 are shown, the fracturing system 400 can include three or two wellbores, as long as the fracturing system 400 includes more than one wellbore. Further, the fracturing system 400 can include more than four wellbores.

The example fracturing system 400 also includes a first pump 404-1, a second pump 404-2, and a third pump 404-3, collectively referred to as a pumping system 404. While the pumping system is shown as including three separate pumps, the pumping system 404 can include fewer than three pumps or more than three pumps. For example, the pumping system 404 can include only a single pump.

The pumping system 404 is fluidly connected to each of the wellbores 402. Specifically, the pumping system 404 can be fluidly connected to each of the wellbores 402, at least in part, through one or more fluid couplings, e.g. fluid coupling 406. In being fluidly connected to each of the wellbores 402, the pumping system 404 can pump fracturing fluid and solid particles, e.g. proppant, into the wellbores 402 for forming and stabilizing fractures through the wellbores 402. Specifically, the pumping system 404 can pump fracturing fluid and solid particles into the wellbores 402 for forming and stabilizing fractures through passages and/or perforations in the wellbores 402. The pumping system 404 can pump fracturing fluid into the wellbores 402 for forming fractures in the wellbores 402 according to the previously described plug-and-perf technique. Further, the pumping system 404 can pump solid particles, e.g. proppant, in a solid-laden fluid stream into the wellbores 402 for stabilizing the fractures according to the previously described plug-and-perf technique. In being fluidly connected to each of the wellbores 402, the pumping system 404 can pump additional components, e.g. additives, into the wellbores 402 for aiding in the formation and/or stabilization of fractures in the wellbores 402.

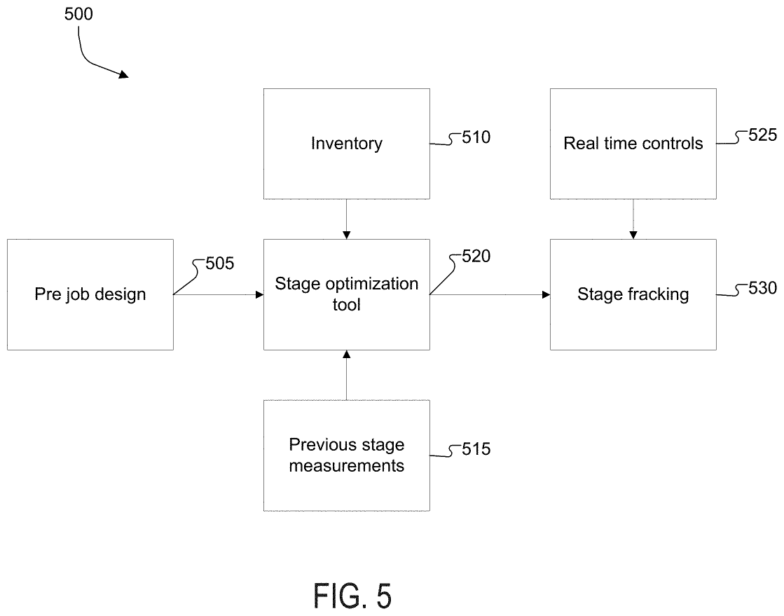

FIG. 5 illustrates an example block diagram of an inter-stage optimization process 500. The inter-stage optimization process 500 can be executed for every stage and iteratively performed between stages. Prior to the start of a next stage, pre job design 505, current status and contents of an inventory 510, and measurements from previous stages 515 can be provided to a stage optimization tool 520. The inventory 510 can include, but are not limited to, information and data relating to available perforating guns, available pumps and their horsepower, a lateral length of an available wellbore, available fluids, available proppant, fracturing plugs, and available chemicals such as friction reducing polymers and gelling agents.

The stage optimization tool 520 can generate an updated design for hydraulic fracturing based on the pre-job design 505, current status of the inventory 510, measurements from previous stages 515, or any other available inputs suitable for the intended purpose and understood by a person of ordinary skill in the art. The updated design can include a completion and treatment plan including specific variables that can be used for a stage fracking process 530, also referred to as hydraulic fracturing as described herein. Real time controls 525 can be adjusted along with the updated design during the stage fracking process 530. For example, controls 525 can be adjusted in real time and include adjusting flow rate, pressure, surfactant, proppant type, chemical additives, proppant mass and/or concentration, and chemical additive type and concentration such as friction reducer, surfactant, gelling agent, etc.

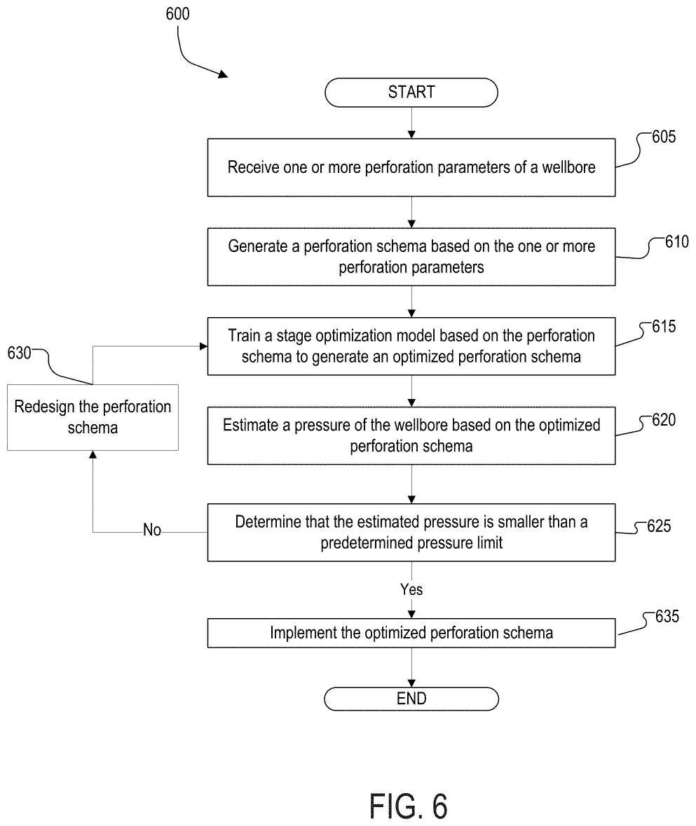

In some implementations, the stage optimization tool 520 can detect a relation between a number of variables relevant to proppant distribution and an objective function, as illustrated and described in FIG. 6. For example, the stage optimization tool 520 can be utilized to maximize a uniformity index (UI). Any physics based, databased, or any other suitable form of models can be utilized for the stage optimization tool 520. In some aspects, stage optimization tool 520 can include machine learning models to maximize the uniformity index.

While the example process 500 in FIG. 5 includes pre job design 505, inventory 510, and previous stage measurements 515 as inputs for the stage optimization tool 520, various implementations will be apparent to those of ordinary skill in the art when practicing the present technology. For example, various inputs such as formation properties, wellbore trajectories, a number of perforations, a number of perforation clusters, diameters of perforations, flow rate, proppant amount, proppant concentration, fluid type, wellbore length, wellbore diameters, cluster spacing, fluid amount, stage length, degree of tapering, proppant loading, etc., can be provided to the stage optimization tool 520. In some implementations, tapering can refer to a situation where at least one of the clusters within a stage includes a different amount of perforations from other clusters within the stage. In some examples, if all of the clusters have the same number of perforations, then there may be no tapering. In other examples, if the number of perforations for at least one of the clusters is different from at least one other cluster, then there may be tapering in the stage. In some aspects, proppant loading can refer to a total proppant divided by a stage length, which can be on a well level or a stage level. The stage optimization tool 520 can also be provided with a set of upper and/or lower limits for variables such as allowable pressure thresholds in the wellbore.

FIG. 6 illustrates an example method 600 for utilizing a stage optimization model to optimize a perforation schema. The method 600 shown in FIG. 6 can be implemented with an applicable fracturing system for hydraulic fracturing. For example, the method 600 in FIG. 6 can be used in the fracturing system 10 shown in FIG. 1.

At step 605, the method 600 can include receiving one or more perforation parameters of a wellbore, as described herein. The perforation parameters can include a total number of perforations, a number of clusters, cluster spacing, shots per clusters, stage length, well length, weight of perforation charges, diameters of the perforations, phasing of perforation charges, perforating gun size, type of perforation charges, perforating gun standoff, etc. The perforation parameters can be identified based on a current inventory, for example, inventory 510 in FIG. 5.

In some examples, any factors that govern proppant distribution and/or downhole fluid can be received at step 605. Such factors include completion variables (e.g., total perforations in a stage, total clusters in a stage, magnitude of tapering of the number of holes per cluster, stage length, etc.), treatment design variables (e.g., total fluid & proppant volume, average treatment rate, FR concentration, number of proppant steps in the treatment, proppant slope within the treatment, maximum proppant concentration, etc.), downhole response variables (e.g., measured surface pressure), proppant schedule variables (e.g., max concentration, proppant sequence, etc.), derived variables (e.g., fluid friction, perforation friction, etc.), and reservoir/formation properties (e.g., mechanical properties, pore pressure, mineralogy, natural fracture distribution, tortuosity, etc.).

In some implementations, the method 600 can include selecting treatment variables such as a flow rate of a slurry or types of fluids. The flow rate of the slurry can be selected from a pre job design (e.g., the pre job design 505 in FIG. 5) or an inventory of pumps (e.g., the inventory 510 in FIG. 5).

At step 610, the method 600 can include generating a perforation schema based on one or more perforation parameters as described herein. In some implementations, the perforation schema can be generated based on the perforation parameters, the factors that govern proppant distribution and/or downhole fluid, treatment variables, anticipated pressure drops, weight of perforation charges, perforation diameters, phasing of the perforation charges, perforating gun size, type of perforation charges, etc. In some implementations, when designing the perforation schema, some constraints can also be used, for example, a fixed number of perforation modules and types, a fixed well length, a fixed cluster spacing, a fixed maximum flow rate from the equipment. Such constraints can be predetermined prior to training the stage optimization model.

At step 615, the method 600 can include training a stage optimization model (e.g., the stage optimization tool 520 of FIG. 5) based on the perforation schema, as described herein, to generate an optimized perforation schema. For example, the stage optimization model can be configured to generate a uniformity index (UI) of cluster flow distribution for each stage of the wellbore. The stage optimization model can utilize any other variable or a combination of variables such as stage-wise production from simulation, fiber measurement, fracture geometry from micro-seismic, Distributed Acoustic Sensing (DAS) data, tilt monitoring, and pressure monitoring from treatment and/or offset wells.

In some implementations, the stage optimization model can be configured to generate uniformity indexes (UI) as a stage level metric based on at least one or a combination of completion variables, treatment variables, response variables, formation characteristics, and derived variables. For example, the UI can be determined by a function of one or a combination of various variables such as completion variables, treatment variables, response variables, formation characteristics, and derived variable. In some aspects, the UI can be based on treatment responses from fiber optic DAS measurements. For example, from the fiber optics DAS measurements, the flow distribution into the clusters can be determined to calculate the UI.

In at least one implementation, a parameter (e.g., a stage level metric) in the stage optimization model can be the UI. For example, if there are four clusters having a flow into each of the clusters being 25% of the total flow, then the UI will be 1 (i.e., 100%) as calculated utilizing Equation (2) below, which is the maximum. The UI can be based on a coefficient of variation cv, which may be determined by Equation (1) below:

c_{ν}=σ/μ (1)

In Equation (1) above, σ denotes the standard deviation of the flow distribution in a particular stage. μ denotes the mean of flow distribution in the stage, which can be equivalent to the flow into one formation entry point in the situation that all entry points in the stage are accepting equal flow distribution. The flow distribution can be determined to meet a predetermined threshold if the calculated coefficient of variation (c_{ν}) meets or exceeds a predetermined value.

In at least one embodiment, the UI can be determined by using the coefficient of variation cv of Equation (1), as expressed in Equation (2) below:

UI=1−σ/μ (2)

For example, using Equation (2), the flow distribution can meet the threshold if the calculated UI is at or below a predetermined value.

In some aspects, the stage optimization model can be trained/retrained to obtain an optimal stage design, i.e., maximum UI under imposed constraints on upper and lower bounds on the variables. For example, the stage optimization tool can be trained based on the perforation schema from step 610 to generate an optimized perforation schema. The optimized perforation schema can be determined by a predetermined threshold, which can be a number or a function of variables. For example, the UI threshold can be directly proportional to a stage length, i.e., the longer the stage length, the higher the UI.

In some examples, a database for various variables, which can be used in the UI function, can be collected by utilizing a fiber in a well. In another implementation, the UI can be inferred from a fracture simulator.

In some implementations, the optimized perforation schema can provide updated completion variables (e.g., a number of perforation, a perforation diameter, perforation distribution, a number of clusters, etc.) and updated treatment variables (e.g., an optimal rate, a proppant scheme, a friction reducer, etc.) for the next stage to maximize performance factors.

In some examples, the stage optimization model can be a machine learning model. As understood by those skilled in the art, a machine-learning model can vary depending on the desired implementation. For example, machine learning models can utilize one or more of the following, alone or in combination of random forests, neural networks such as recurrent neural networks (RNNs) or convolutional neural networks (CNNs), hidden Markov models, Deep Learning networks, Bayesian symbolic methods, general adversarial networks (GANs), support vector machines, image registration methods, and/or applicable rule-based systems.

The stage optimization model can use an applicable machine learning technique to predict the uniformity index (UI) and generate an optimized perforation schema. Using machine learning can be advantageous as a human is typically unable to timely analyze the wealth of completion variables, treatment variables, response variables, formation characteristics, derived variable, and any other factors that govern proppant distribution to determine the UI and generate the optimized perforation schema. These advantages are further realized when fracturing is performed on multiple wellbores, as illustrated in FIG. 4 and potentially simultaneously on the multiple wellbores. Applying machine learning can insure that the numerous and complex variables that influence proppant distribution are properly accounted for in selecting the UI and generating the optimized perforation schema.

In some implementations, if the UI is determined to be unacceptable, the process including steps 605, 610, and 615 can be repeated by relaxing some constraints. For example, a hierarchy table of constraint relaxation can be built either based on parameters or variables that can be changed (e.g., reconfiguring the perforating gun to change the number of shots) or based on mathematical considerations such as feature importance in the machine learning model, sensitivity analysis, or any other suitable criteria. Other examples of constraints that can be adjusted include stage length, a total number of perforations, degree of tapering, gun size and type, phasing, weight of perforation charge, perforation diameters, fluid types (e.g., FR type), maximum proppant concentration, a total amount of proppant and fluid, etc.

At step 620, the method 600 can include estimating a pressure of the wellbore based on the optimized perforation schema that was generated by the stage optimization model at step 615. The pressure of the wellbore can be estimated by utilizing a pressure prediction model, which can be executed for some or every stage, and iteratively performed between stages or treatments. The perforation optimization (e.g., the optimized perforation schema) and the stage optimization (e.g., the stage optimization model), as described herein, can be performed before the next stage, for the next couple of stages, or for the whole well at the beginning of the process. In some implementations, the perforation optimization and the stage optimization can be performed for multiple wells, simultaneously and/or in real time.

In some implementations, the pressure prediction model can use an applicable machine learning technique, a fracture model to estimate pressure, or any other model or technique suitable for the intended purpose and understood by a person of ordinary skill in the art. The machine learning pressure prediction model can be based on a past well stage database, which can include, but is not limited to, previous stage pressure, measured depth, true vertical depth, a flow rate of a slurry, and a perforation friction. For example, a pressure model can be determined by a function of one or a combination of previous stage pressure, measured depth, true vertical depth, a flow rate of a slurry, and a perforation friction.

In some examples, a perforation friction can be determined by Equation (3) below:

$$Perforation Friction = \frac{{Q}^{2} ρ}{{n}_{p}^{2} {D}_{p}^{2} {C}_{d}^{2}} \qquad ( 3 )$$

where Q refers to an injection rate, ρ refers to a fluid density, nₚ refers to a number of perforations, Dₚ refers to a perforation diameter, and C_{d} refers to a coefficient of discharge.

At step 625, the method 600 can include determining whether the estimated pressure from step 620 is less than a predetermined pressure limit. In some implementations, the estimated pressure can be determined whether it is within a range of a predetermined pressure limit. If the estimated pressure is greater than the predetermined pressure limit, the perforation schema can be updated or redesigned at step 630. In some aspects, the perforation schema can be redesigned by adjusting the pumping fluid, proppant volume according to stage length (e.g., delivering a certain amount of proppant per foot), stage length, a total number of perforations, degree of tapering, gun size and types, phasing, weight of perforation charge, perforation diameters, fluid type (e.g., FR type), maximum proppant concentration, total amount of proppant and fluid, etc. The optimized perforation schema can be updated iteratively until the estimated pressure is less than the predetermined pressure limit by repeatedly training the stage optimization model at step 615.

At step 635, the method 600 can include implementing the optimized perforation schema. Once it is determined that the estimated pressure is less than the predetermined pressure limit at step 625, the optimized perforation schema can be implemented for hydraulic fracturing at step 635. In some implementations, the method 600 can be repeated until a fracturing pad is completed or the inventory is empty.

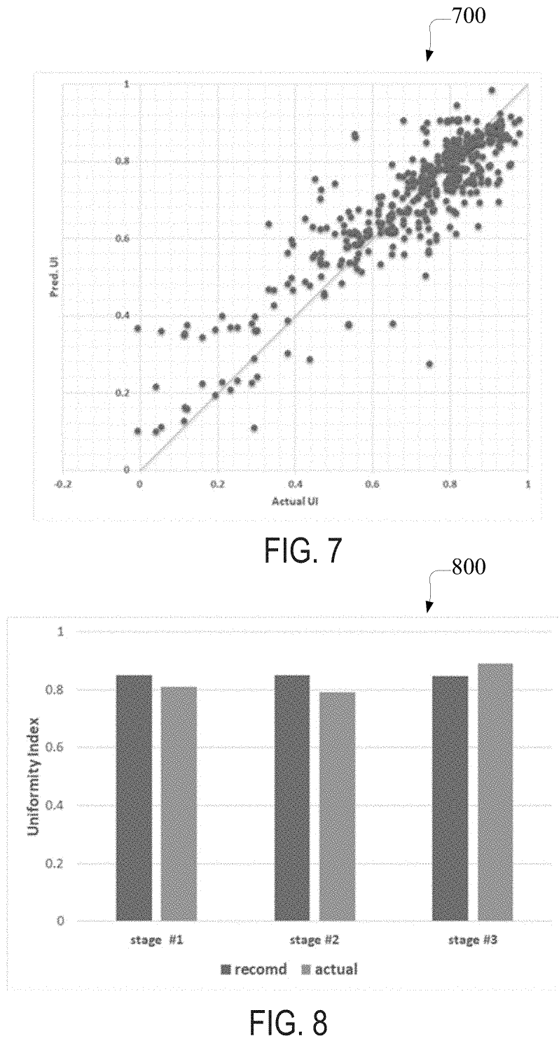

FIG. 7 illustrates an example graph of a performance comparison of a uniformity index (UI) 700. The example graph 700 in FIG. 7 shows the comparison between predicted UIs and actual UIs. An ensemble model (e.g., a machine learning model) can be utilized to generate the graph 700. The model predictions shown in FIG. 7 are predictions for the held-out validation data from a 5-fold cross-validated data set. The root-mean square error is 0.09. In the example graph 700 of FIG. 7, the aggregation of data along the identity line, i.e., line of equality, demonstrates the accuracy of the stage optimization tool (e.g., which can utilize a machine learning model) employed in accordance with the present disclosure.

FIG. 8 illustrates an example graph of a uniformity index (UI) in three different stages 800. A bar to the left of each stage can represent a model recommendation. A bar to the right of each stage can represent actual field results. In this example, the stage optimization model can be utilized in a field to generate a recommended perforation schema at different stages. For example, a recommended perforation schema can include a stage length of 300 ft and a cluster spacing of 30 ft, which then were utilized in three different stages (e.g., Stage #1, Stage #2, and Stage #3 as illustrated in FIG. 8). The predicted UI based on the perforation schema recommended by the stage optimization model is approximately 0.82 for all three stages, while actual UIs for Stage #1, Stage #2, and Stage #3 is approximately 0.80, 0.79 and 0.84, respectively. Such a small difference between the predicted UI value and the actual UI values demonstrate a confirmatory agreement between the model optimized output and the actual field results, for the different three stages as illustrated in FIG. 8.

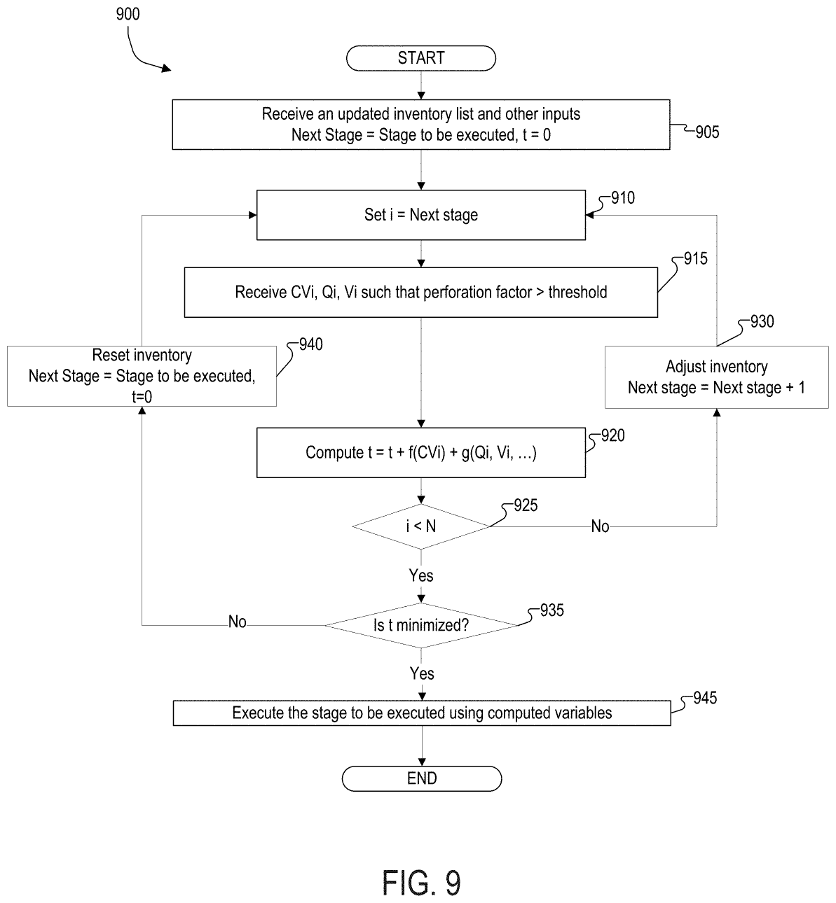

FIG. 9 illustrates an example method 900 for optimizing a time saving parameter. The method 900 of FIG. 9 can identify a minimum value for the time saving parameter so that the surface efficiency can be maximized, for example, a decreased number of stages and an increased pumping rate. In this example, the time saving parameter can be used as a performance factor, i.e., a surface efficiency improvement index. Any other suitable indicators (e.g., cost and well completion time) can be used or combined with the time saving parameter to indicate the surface efficiency improvement. A sequence of steps or calculations may appear differently in various implementations.

In some implementations, the method 900 for optimizing a time saving parameter can be an inter-stage algorithm, i.e., the algorithm can be executed before the execution of the next stage. Also, the method 900 can be performed between the stages based on the measurements performed on-site in conjunction with data-driven model. In some aspects, inputs or inventories, such as pre job design 505, inventory 510, and previous stage measurement 515 shown in FIG. 5, can vary depending on the type of model utilized in identifying the optimized performance factor, for example, a minimum time saving parameter as described in the method 900.

At step 905, the method 900 can include receiving an updated inventory list and other inputs. A next stage is set as a stage that can be executed with t (time) being set to 0. In some implementations, the inventory can contain two types of information: (1) specific to a well, for example, available well length; and (2) shared inventory, such as available fluid, proppant, friction reducer, or gum modules. For example, if a certain amount of proppant in a well is needed for a job, proppant may not be shared across the wells. Furthermore, the inputs can include geo-mechanical details and on-site measurements up to and including the current stage.

As follows, i is set to be a next stage at step 910.

At step 915, the method 900 can include receiving one or more completion and treatment variables associated with a time to complete a cluster design and a time to complete pumping. The completion and treatment variables can be determined such that a perforation factor can be greater than a predetermined threshold. In some examples, the threshold can be the UI. In some aspects, the method can include receiving the CV, Q, and V, and checking to ensure that the perforation factor exceeds the minimum threshold.

At step 920, the method 900 can include generating a time saving parameter, as described herein, based on the time to complete the cluster design and the time to complete the pumping. For example, the time saving parameter can be determined by Equation (4) below:

t=Σᵢ^{N}ƒ(CVᵢ)+g(Qᵢ,Vᵢ, . . . ) (4)

where the ƒ function refers to a computation of time to complete a cluster design and the g function refers to a computation of time to complete pumping. CVᵢ denotes completion variables for stage i, Qᵢ denotes an injection rate, and Vᵢ denotes the total volume of the fluids pumped for stage i. N denotes the total number of stages.

In some implementations, the treatment variables can include a rate at which fluids are pumped downhole and a volume of fluid that is being pumped. For example, an implementation for the g function can be expressed as Equation (5) below:

g(Vᵢ,Qᵢ)=Vᵢ/Qᵢ (5)

where Vᵢ denotes the total volume of the fluids pumped and Qᵢ denotes a flow rate. Other implementations can incorporate full details of the pumping schedule, as described herein. In some examples, real time controls, for example real time controls 525 as illustrated in FIG. 5, can affect the time to complete pumping by adjusting controls accordingly, as described in the present disclosure.

In some examples, the time to complete the cluster design can be an average of an expected time of completing a stage of the wellbore. For example, the time to complete the cluster design can be expressed as Equation (6) below:

ƒ(CVᵢ)=α (6)

where a denotes the expected average time of completing a single stage. Other implementations can involve more complicated details such as the depth of the stage location (i.e., how deep the stage is located), how fast a gun can be pumped down, how long it takes to shoot the clusters, etc.

At step 925, the method 900 can include determining that i is less than N, which can denote the total number of stages.

If i is not less than N, the inventory can be adjusted and the next stage can be set to be next stage+1 (e.g., the next subsequent stage) at step 930 so that steps 910 to 925 can be repeated until i becomes less than the total number of stages.

At step 935, the method 900 can include determining whether the time saving parameter t is minimized so that the time saving parameter t can be updated by controlling an inventory until the time saving parameter is minimized to a predetermined threshold. In some implementations, the time saving parameter/threshold t (e.g., at step 935 of the method 900) can be a percentage of an initial design. For example, the method 900 can include being minimized to at least 10% below an initial time or minimizing the initial total time for a respective stage/well.

If the time saving parameter t is not minimized, the inventory can be reset at step 940. The next stage can then be set as a stage to be executed and t can be set to 0. Steps 910 to 935 can further be iteratively performed until the time saving parameter t reaches a minimum value.

At step 945, once the minimum time saving parameter is achieved, the method 900 can include executing the stage using computed variables. In some implementations, decreasing the number of stages and increasing the rate can assist in reducing the time, thereby minimizing the time saving parameter t. However, simply increasing the stage length to decrease the number of stages may not always improve the time saving parameter i if the rate is reduced to maintain other objectives. Similarly, simply increasing the pumping rate may not lead to a reduction in time if the number of stages tends to increase. In some implementations, the method 900 can include adjusting various variables to minimize the time saving parameter t such as total fluid pumped, proppant pumped, cluster spacing, total number of perforations, and lowering the UI constraint.

Furthermore, in another example, the performance indicator can be determined by various models, such as a real-time tuned (e.g., based on the measurements) fracture propagation model that can provide a fracture geometry as a performance indicator, a real-time tuned fracking propagation in combination with a reservoir model providing a production estimate as a performance indicator, a machine learning model based on other measurements such as micro-seismic, das-strain/stress, tilt meter, etc. In some implementations, the performance indicator may be a reduction in well interference, especially when there are parent wells nearby. In such scenarios, a real time parent-child well interference control can be utilized as a performance indicator. In some examples, the performance indicator can include reduced misplaced proppants, reduced misplaced slurries, and increased fracture complexities.

In some implementations, the method 900 can utilize a real-time calculator as available inventory can change during the hydraulic fracturing operation. For example, a stage may be abandoned or cut short, thereby leading to a change in the available inventory.

In other implementations, the stage performance indicator can also be computed based on on-site measurements. Alternatively, the method 900 can be performed based on a prior estimation, for example, an estimate based on a non-real time model that generates a first estimate. The first estimate can further be improved and adjusted during real-time operation.

Furthermore, in additional implementations, the method 900 can be performed for each individual stage of the fracturing operation to reduce operation time in order to improve surface efficiency of the fracturing operation.

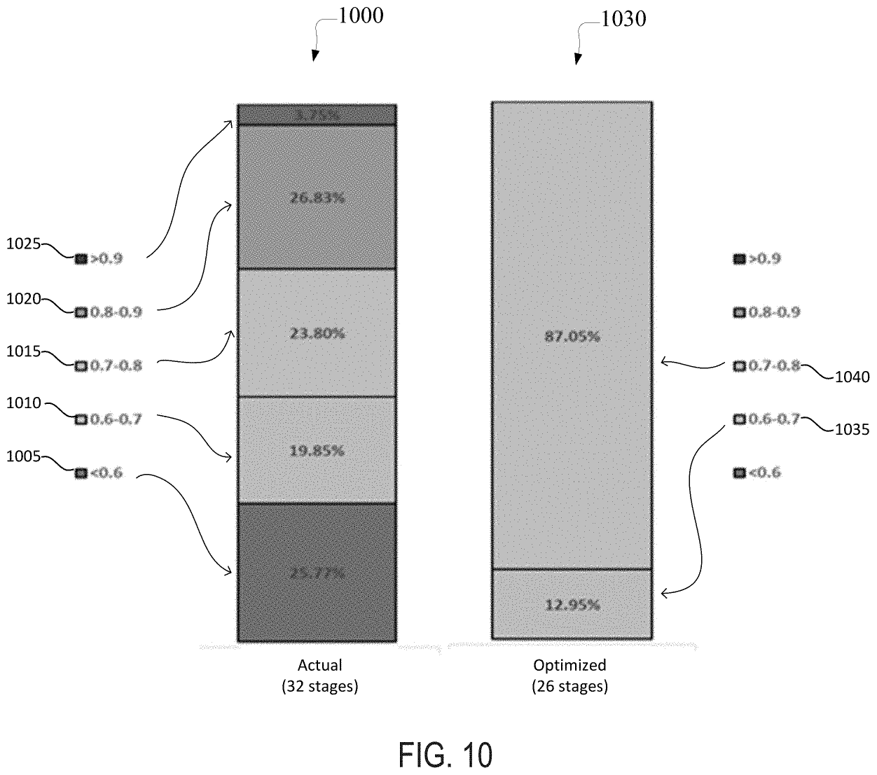

FIG. 10 illustrates an example of well optimization in accordance with aspects of the present disclosure. Referring to FIG. 10, the actual design 1000 includes 32 stages, while the optimized design 1030 includes 26 stages based on the processes, methods, and systems described herein (e.g., as described and illustrates in FIGS. 5-9). The percentages in the graphs of the actual design 1000 and the optimized designed 1030, respectively, illustrate lateral length percentages for a well within a given UI range. For example, in the actual design 1000, 25.77% of the lateral length 1005 has a UI value approximately less than 0.6. Lateral length 1010 includes a percentage of 19.85% and has a UI value within an approximate range between 0.6 and 0.7. Lateral length 1015 includes a percentage of 23.80% and has a UI value within an approximate range between 0.7 and 0.8. Lateral length 1020 includes a percentage of 26.83% and has a UI value within an approximate range between 0.8 and 0.9. Lateral length 1025 includes a percentage of 3.75% and has a UI value approximately greater than 0.9. In the optimized design 1030, all stages 1035, 1040 include UI values approximately over 0.6.

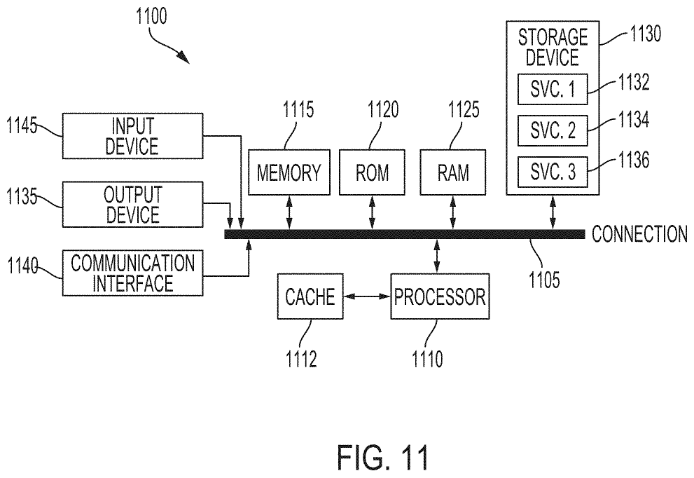

FIG. 11 illustrates an example computing device architecture 1100, which can be employed to perform various steps, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 11 illustrates an example computing device architecture 1100 of a computing device, which can implement the various technologies and techniques described herein. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general purpose processor and a hardware or software service, such as service 1 1132, service 2 1134, and service 3 1136 stored in storage device 1130, configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or grail input, keyboard, mouse, motion input, speech and so forth. An output device 1135 can also be one or more of a number of output mechanisms known to those of skill in the art, such as a display, projector, television, speaker device, etc. In some instances, multimodal computing devices can enable a user to provide multiple types of input to communicate with the computing device architecture 1100. The communications interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include services 1132, 1134, 1136 for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data, which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the Disclosure Include:

Statement 1: A method comprising: receiving one or more perforation parameters of a wellbore; generating a perforation schema based on the one or more perforation parameters; training a stage optimization model based on the perforation schema to generate an optimized perforation schema; estimating a pressure of the wellbore based on the optimized perforation schema; and updating the optimized perforation schema until the estimated pressure is less than a predetermined pressure limit.

Statement 2: The method of Statement 1, wherein the stage optimization model is configured to generate a uniformity index of cluster flow distribution for each stage of the wellbore.

Statement 3: The method of any of Statements 1 to 2, wherein the stage optimization model is configured to generate a uniformity index of cluster flow distribution based on at least one of completion variables, treatment variables, response variables, formation characteristics, derived variables, or a combination thereof.

Statement 4: The method of any of Statements 1 to 3, wherein the stage optimization model is a machine learning model.

Statement 5: The method of any of Statements 1 to 4, further comprising: receiving one or more completion and treatment variables associated with a time to complete a cluster design and a time to complete pumping; generating a time saving parameter based on the time to complete the cluster design and the time to complete the pumping; and updating the time saving parameter by controlling an inventory until the time saving parameter is minimized to a predetermined threshold.

Statement 6: The method of any of Statements 1 to 5, wherein the one or more completion and treatment variables include a pumping rate and a volume of pumped fluid.

Statement 7: The method of any of Statements 1 to 6, wherein the time to complete the cluster design is an average of an expected time of completing a stage of the wellbore.

Statement 8: A system comprising: one or more processors; and at least one computer-readable storage medium having stored therein instructions which, when executed by the one or more processors, cause the system to: receive one or more perforation parameters of a wellbore; generate a perforation schema based on the one or more perforation parameters; train a stage optimization model based on the perforation schema to generate an optimized perforation schema; estimate a pressure of the wellbore based on the optimized perforation schema; and update the optimized perforation schema until the estimated pressure is less than a predetermined pressure limit.

Statement 9: The system of Statement 8, wherein the stage optimization model is configured to generate a uniformity index of cluster flow distribution for each stage of the wellbore.

Statement 10: The system of any of Statements 8 to 9, wherein the stage optimization model is configured to generate a uniformity index of cluster flow distribution based on at least one of completion variables, treatment variables, response variables, formation characteristics, derived variables, or a combination thereof.

Statement 11: The system of any of Statements 8 to 10, wherein the stage optimization model is a machine learning model.

Statement 12: The system of any of Statements 8 to 11, wherein the instructions, when executed by the one or more processors, further cause the system to: receive one or more completion and treatment variables associated with a time to complete a cluster design and a time to complete pumping; generate a time saving parameter based on the time to complete the cluster design and the time to complete the pumping; and update the time saving parameter by controlling an inventory until the time saving parameter is minimized to a predetermined threshold.

Statement 13: The system of any of Statements 8 to 12, wherein the one or more completion and treatment variables include a pumping rate and a volume of pumped fluid.

Statement 14: The system of any of Statements 8 to 13, wherein the time to complete the cluster design is an average of an expected time of completing a stage of the wellbore.

Statement 15: A non-transitory computer-readable storage medium comprising: instructions stored on the non-transitory computer-readable storage medium, the instructions, when executed by one or more processors, cause the one or more processors to: receive one or more perforation parameters of a wellbore; generate a perforation schema based on the one or more perforation parameters; train a stage optimization model based on the perforation schema to generate an optimized perforation schema; estimate a pressure of the wellbore based on the optimized perforation schema; and update the optimized perforation schema until the estimated pressure is less than a predetermined pressure limit.

Statement 16: The non-transitory computer-readable storage medium of Statement 15, wherein the stage optimization model is configured to generate a uniformity index of cluster flow distribution for each stage of the wellbore.

Statement 17: The non-transitory computer-readable storage medium of any of Statements 15 to 16, wherein the stage optimization model is configured to generate a uniformity index of cluster flow distribution based on at least one of completion variables, treatment variables, response variables, formation characteristics, derived variables, or a combination thereof.

Statement 18: The non-transitory computer-readable storage medium of any of Statements 15 to 17, wherein the stage optimization model is a machine learning model.

Statement 19: The non-transitory computer-readable storage medium of any of Statements 15 to 18, the instructions, when executed by one or more processors, further cause the one or more processors to: receive one or more completion and treatment variables associated with a time to complete a cluster design and a time to complete pumping; generate a time saving parameter based on the time to complete the cluster design and the time to complete the pumping; and update the time saving parameter by controlling an inventory until the time saving parameter is minimized to a predetermined threshold.

Statement 20: The non-transitory computer-readable storage medium of any of Statements 15 to 19, wherein the one or more completion and treatment variables include a pumping rate and a volume of pumped fluid.

What is claimed is:

1. A method comprising:
receiving one or more perforation parameters of a wellbore;
generating a perforation schema based on the one or more perforation parameters;
training a stage optimization model based on the perforation schema to generate an optimized perforation schema;
estimating a pressure of the wellbore based on the optimized perforation schema; and
updating the optimized perforation schema until the estimated pressure is less than a predetermined pressure limit.

2. The method of claim 1, wherein the stage optimization model is configured to generate a uniformity index of cluster flow distribution for each stage of the wellbore.

3. The method of claim 1, wherein the stage optimization model is configured to generate a uniformity index of cluster flow distribution based on at least one of completion variables, treatment variables, response variables, formation characteristics, derived variables, or a combination thereof.

4. The method of claim 1, wherein the stage optimization model is a machine learning model.

5. The method of claim 1, further comprising:
receiving one or more completion and treatment variables associated with a time to complete a cluster design and a time to complete pumping;
generating a time saving parameter based on the time to complete the cluster design and the time to complete the pumping; and
updating the time saving parameter by controlling an inventory until the time saving parameter is minimized to a predetermined threshold.

6. The method of claim 5, wherein the one or more completion and treatment variables include a pumping rate and a volume of pumped fluid.

7. The method of claim 5, wherein the time to complete the cluster design is an average of an expected time of completing a stage of the wellbore.

8. A system comprising:
one or more processors; and
at least one computer-readable storage medium having stored therein instructions which, when executed by the one or more processors, cause the system to:
receive one or more perforation parameters of a wellbore;
generate a perforation schema based on the one or more perforation parameters;
train a stage optimization model based on the perforation schema to generate an optimized perforation schema;
estimate a pressure of the wellbore based on the optimized perforation schema; and
update the optimized perforation schema until the estimated pressure is less than a predetermined pressure limit.

9. The system of claim 8, wherein the stage optimization model is configured to generate a uniformity index of cluster flow distribution for each stage of the wellbore.

10. The system of claim 8, wherein the stage optimization model is configured to generate a uniformity index of cluster flow distribution based on at least one of completion variables, treatment variables, response variables, formation characteristics, derived variables, or a combination thereof.

11. The system of claim 8, wherein the stage optimization model is a machine learning model.

12. The system of claim 8, wherein the instructions, when executed by the one or more processors, further cause the system to:
receive one or more completion and treatment variables associated with a time to complete a cluster design and a time to complete pumping;
generate a time saving parameter based on the time to complete the cluster design and the time to complete the pumping; and
update the time saving parameter by controlling an inventory until the time saving parameter is minimized to a predetermined threshold.

13. The system of claim 12, wherein the one or more completion and treatment variables include a pumping rate and a volume of pumped fluid.

14. The system of claim 12, wherein the time to complete the cluster design is an average of an expected time of completing a stage of the wellbore.

15. A non-transitory computer-readable storage medium comprising:
instructions stored on the non-transitory computer-readable storage medium, the instructions, when executed by one or more processors, cause the one or more processors to:
receive one or more perforation parameters of a wellbore;
generate a perforation schema based on the one or more perforation parameters;
train a stage optimization model based on the perforation schema to generate an optimized perforation schema;
estimate a pressure of the wellbore based on the optimized perforation schema; and
update the optimized perforation schema until the estimated pressure is less than a predetermined pressure limit.

16. The non-transitory computer-readable storage medium of claim 15, wherein the stage optimization model is configured to generate a uniformity index of cluster flow distribution for each stage of the wellbore.

17. The non-transitory computer-readable storage medium of claim 15, wherein the stage optimization model is configured to generate a uniformity index of cluster flow distribution based on at least one of completion variables, treatment variables, response variables, formation characteristics, derived variables, or a combination thereof.

18. The non-transitory computer-readable storage medium of claim 15, wherein the stage optimization model is a machine learning model.

19. The non-transitory computer-readable storage medium of claim 15, the instructions, when executed by one or more processors, further cause the one or more processors to:
receive one or more completion and treatment variables associated with a time to complete a cluster design and a time to complete pumping;
generate a time saving parameter based on the time to complete the cluster design and the time to complete the pumping; and
update the time saving parameter by controlling an inventory until the time saving parameter is minimized to a predetermined threshold.

20. The non-transitory computer-readable storage medium of claim 19, wherein the one or more completion and treatment variables include a pumping rate and a volume of pumped fluid.
